(19) United States
(12) Patent Application Publication
(10) Pub. No.: US 2003/0212900 A1
(43) Pub. Date: Nov. 13, 2003

(54) Packet classifying network services

(76) Inventors: Hsin-Yuo Liu, Hillsboro, OR (US); Puqi Tang, Portland, OR (US)

Correspondence Address: FISH & RICHARDSON, PC, 4350 LA JOLLA VILLAGE DRIVE, SUITE 500, SAN DIEGO, CA, 92122, US

(21) Appl. No.: 10/145,378

(22) Filed: May 13, 2002

(51) Int. Cl. H04L 9/00

(52) U.S. Cl. 713/200

(57) ABSTRACT

A system for updating classification chains, including but not limited to firewall ACLS, can include a network device having a plurality of interfaces to receive and transmit packets of data, a forwarding element to apply classification rules to the packets, and a packet classification chain that resides at least temporarily on the network device, wherein the chain includes classification rules, an associated action, and an update field to trigger insertion or deletion of the rule.

### TECHNICAL FIELD

Certain illustrative embodiments relate to information management and, more specifically, to packet-classification network services such as firewalls.

### BACKGROUND

Networks of computers such as intranets, local and wide area networks, and the Internet exchange information in “packets.” A packet includes data such as files and programs and can also include a header that contains information that identifies the packet and indicates its origin and destination. The header can further include network protocol identifiers and the version number of the protocol that is to be used to route the information through the networks. The header can also contain information identifying the port on the source computer from which the packet was sent and the port on the destination computer to which the packet is to be sent.

Computers connected to the Internet can be given either static or dynamic Internet Protocol, or IP, addresses. Packets exchanged through the Internet accordingly often include a source IP address, a destination IP address, an IP protocol identifier and source and destination port numbers.

There is a need in computer networks, including the Internet, to control the exchange of packets in order to prevent the unauthorized disclosure, modification, or execution of data and programs on a networked computer. In packet-switching networks, this is often accomplished through the use of an Access Control List, or ACL, that contains filter rules which indicate whether a packet should be accepted or dropped based on the identifiers included in the packet header.

ACLs are typically implemented, or enforced, by a network device known as firewall. Firewalls are often a combination of software and hardware that receives a packet and then compares the source, destination, protocol and/or other identifiers in the packet header to determine which filter rule “correspond,” or applies, to the packet. The firewall then applies the first corresponding rule to the packet in the order they are set forth in a firewall rule table. A filter rule is applied by determining whether the identifiers set forth in the packet header match or fall within the range of values set forth in the filter rule for each identifier. If all of the packet header fields match the parameters set forth in a filter rule, an action, typically an ACCEPT/DROP action, is carried out on the packet. If the packet header do not match the field values specified in the corresponding filter rule, the next corresponding filter rule is compared with the packet, and the above-described process is repeated. If a packet header does not satisfy any of the corresponding rules, or if no rules are found to match the packet header, a default action, usually a DROP action, is carried out on the packet. The default rule is often the last rule in the firewall rule table.

In recent years, secure protocols such as Internet Security Protocol (IPsec) have been implemented. Some secure protocols encrypt both the packet and one or more identifiers in the packet header (such as the inner port, inner IP address and inner protocol information). The encryption of the packet header information complicates enforcement of filter rules because a standard ACL is able only to query and evaluate clear, or unencrypted, packet headers.

Further difficulties can be posed by the introduction of an open network (“ON”) architecture wherein the router includes a control element (CE) that creates and manages the filter rules and a separate forwarding element (FE) that forwards the packets toward to their destination. Such architectures are “open” in the sense that there can be multiple forwarding elements managed by a single control element. In certain ON systems an effective decryption technique must be implemented across a multiplicity of forwarding elements with a single control element.

### DESCRIPTION OF DRAWINGS

FIG. 1A is a block diagram of an ON router with a single FE and wherein elements of the router apply filter rules to encrypted packet headers.

FIG. 1B is a block diagram showing further aspects of the ACL and encryption (SITP) information depicted in FIG. 1A.

FIG. 2 is a block diagram of an exemplary graph of filter chains generated by the FRC of FIGS. 1A and 1B.

FIG. 3 is a filter table that is part of the graph of filter chains depicted in FIG. 2.

FIG. 4 is a flow diagram showing the process of inserting a filter rule from a filter table.

FIG. 5 is a flow diagram showing the process of deleting a filter rule to a filter table.

FIG. 6 is a flow diagram showing the process of updating the filter table stored on the FE of FIG. 1A.

Like reference symbols in the various drawings indicate like elements.

### DETAILED DESCRIPTION OF ILLUSTRATIVE EMBODIMENTS

A system for updating classification chains such as filter chains can be realized by, for example, selectively adding or deleting rules from an updated graph of filter chains in response to a filter rule update. In certain illustrative embodiments, the graph of filter chains can include one or more filter tables, or chains), each of which can include one or more filter rules that have filter parameters, a specified ACCEPT or DROP action, and INSERT and DELETE bits. Where an update calls for the addition and deletion of selected rules from a filter table, the FE can optionally mark the appropriate rules for insertion or deletion and, in response to a COMMIT signal, call the appropriate functions to perform the indicated INSERT or DELETE operations directly on to the active filter table. In certain preferred embodiments, this approach can significantly reduce memory usage, computing complexity, system call frequency, and statistics flush problems.

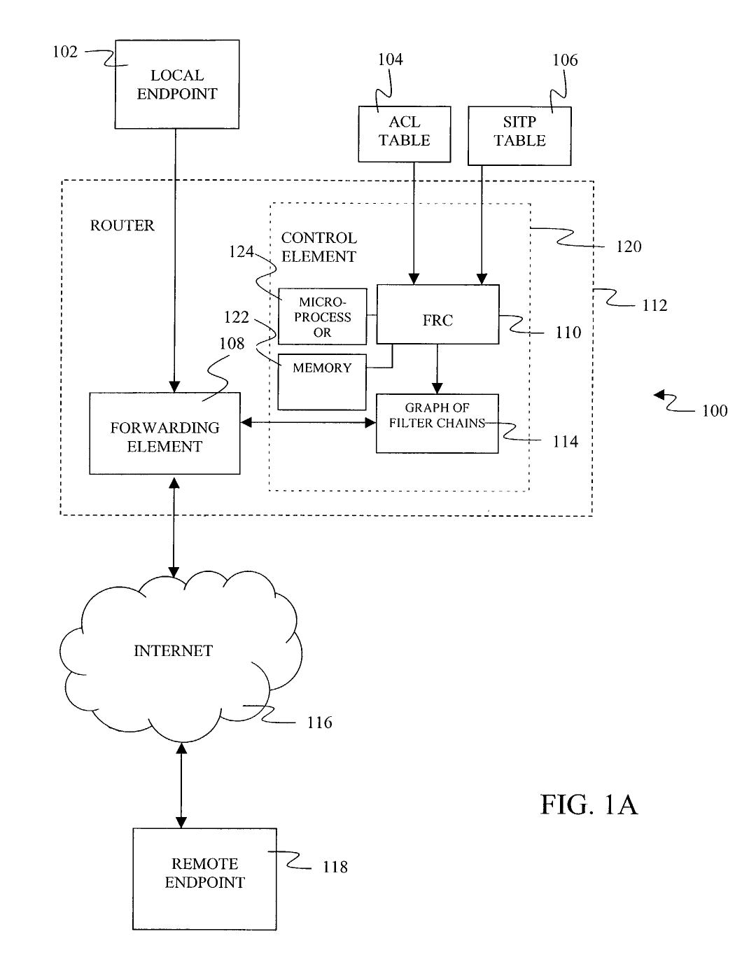

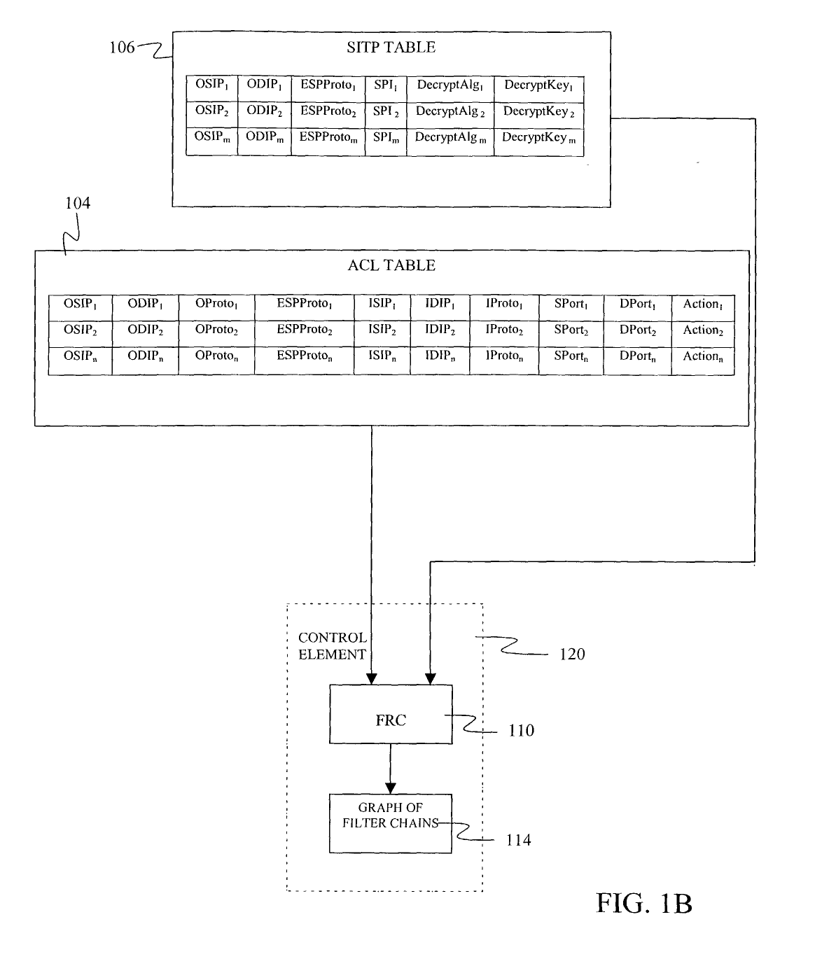

The above-referenced exemplary method for updating packet classification will be further described in the context of a IPsec-aware firewall service, although the method can be readily implemented in other environments involving packet classification. FIG. 1A shows an illustrative network architecture 100 for filtering packets with encrypted packet headers. The virtual private network (“VPN”) shown in FIG. 1A includes a local IPsec endpoint 102 and a remote endpoint 118 accessed via a public domain such as Internet 116. The VPN can optionally include plurality of local networked computers, sometimes referred to as an intranet, in which case there would be a multiplicity of local IPsec endpoints. The VPN can further include additional remote endpoints 118 accessed via any public domain such as the Internet 116. The remote endpoint 118 shown in FIG. 1A is connected to the local IPsec endpoints 102 through the forwarding element 108 in a data network device, which in this embodiment is an ON router 112. The forwarding element can be a combination of hardware and software configured to forward data. The forwarding element 108 includes or is connected to one or more Internet hosts. The forwarding element 108 is connected or networked with a control element 120 that includes a Filter Rule Constructor (FRC) program run on one or more networked computers having memory 122 and microprocessors 124. In a typical ON router construction, there are multiple forwarding elements 108. Generally, there is at least one forwarding element connected to the Internet host(s) 116 and at lest one forwarding element connected to the VPN endpoint 102 or other local computer(s). A plurality of remote users 118 can be connected to the Internet.

In operation, the FRC 110 receives an Access Control Listing (ACL) table 104 and a SITP mapping table 106 and thereafter generates a graph of filter chains 114. The control element downloads the filter chain graph 114 to the forwarding element 108. The forwarding element 108 applies the filter rules embodied in the filter chains 114 to all packets received and route the packets pursuant to the identifiers in the packet headers.

FIG. 1B depicts in more detail an illustrative ACL table 104 and SITP mapping table 106 that can be input into the FRC 110. An ACL entry in one implementation constitutes a 9-tuple, or 9 parameter filter, plus an action. The ACL 9-tuple is the outer source IP address (OSIP), the outer destination IP address (ODIP), the outer protocol (OProto), the ESP protocol (ESPProto), the inner source IP address (ISIP), the inner destination IP address (IDIP), the inner protocol (IProto), the source port (SPort), and the destination port (Dport). The action included in the ACL entry is typically ACCEPT or DROP for firewall. Entries of the SITP table are the 4-tuple OSIP, ODIP, ESPProto, and the security payload index (SPI). The SITP table can also include decryption algorithm identifiers and decryption keys for each of the 4-tuples. The identifiers or parameters set forth in the 9-tuple of the ACL entry and the 4-tuple of the SITP entry can be precise values or they can include wildcards or a value range. For example, IDIP can be 144.34.*.2, which will correspond to inner destination IP addresses 144.34.954.2, 144.34.123.2, etc. The ACL table 104 has entries for “n” filter rules (labeled 1, 2, through n). Likewise, the SITP table 106 contains security mapping for “m” IPsec mappings.

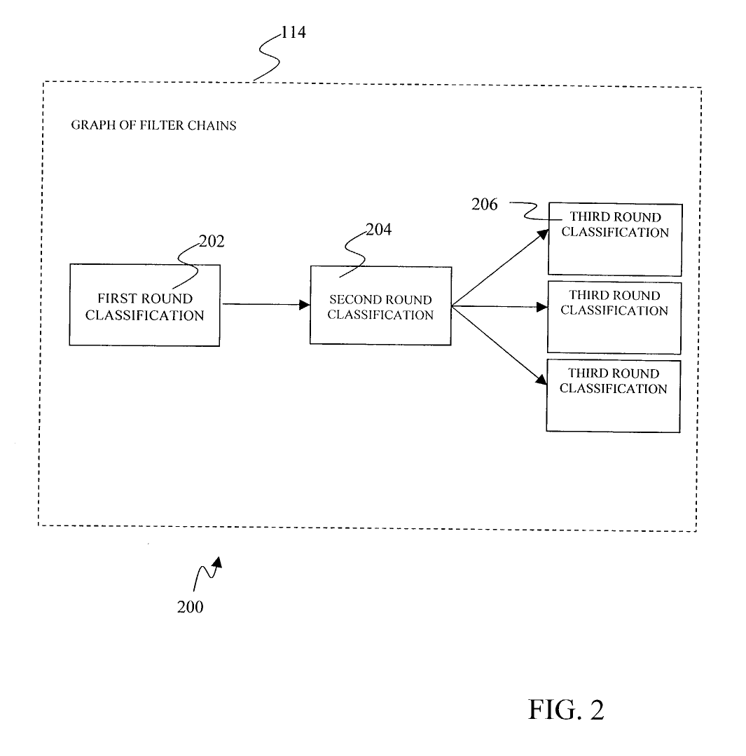

In operation, the FRC 110 can merge the ACL table 104, which is adapted primarily for clear packet headers, and the SITP mapping table 106, which describes how packets have certain specified identifiers should be decrypted. The resulting graph of filter chains 114 is shown in FIG. 2. The graph of filter chains in this embodiment include a first round classification 202, which can optionally be a clear filter chain that has a plurality of rules to be applied to clear packet headers. The first rule in the clear filter chain can provide that any encrypted packets, such as IPsec encrypted packets, be evaluated by an outer 4-tuple chain. The graph 114 can further include a second round classification 204, which can optionally be an outer chain 4-tuple that includes OSIP, ODIP, OProto, and SPI. Pursuant to the outer chain filter table, packets having headers that correspond to, or match, the 4-tuple values (or ranges of values), can be first decrypted and then their inner part can be evaluated by an third round classification 206. In certain embodiments, the third round classification 206 is an inner chain that preferably includes either the 3-tuple ESPProto, DPort, and SPort (in transport mode) or the 6-tuple ESPProto, ISIP, IDIP, IProto, DPort,and SPort (in tunneling mode). Tunneling mode is an ESP mode that encrypts an entire IP packet including at least some of the IP header, whereas transport mode is an ESP mode that encrypts the data contents of a packet and leaves the original IP addresses in plaintext. The inner filter rule tables can include both types filter rules. The inner filter tables also include an action such as ACCEPT or DROP that is to be carried out on the packets whose inner headers correspond to the values or ranges of values specified in the inner filter rule tables (an IPsec tunnel mode packet has an inner header and an outer header; the former is assembled by the host and the second is constructed by the device that is providing security services).

It should be noted that in certain tunneling mode implementations, a packet's inner source IP address (ISIP), the inner destination IP address (IDIP), the inner protocol (IProto), the source port (SPort), and the destination port (Dport) are encrypted, while the remainder of the header parameters are clear, or unencrypted. In such embodiments, an outer chain decrypts the encrypted packet headers and forwards packets to an inner chain which applies the appropriate filter rules.

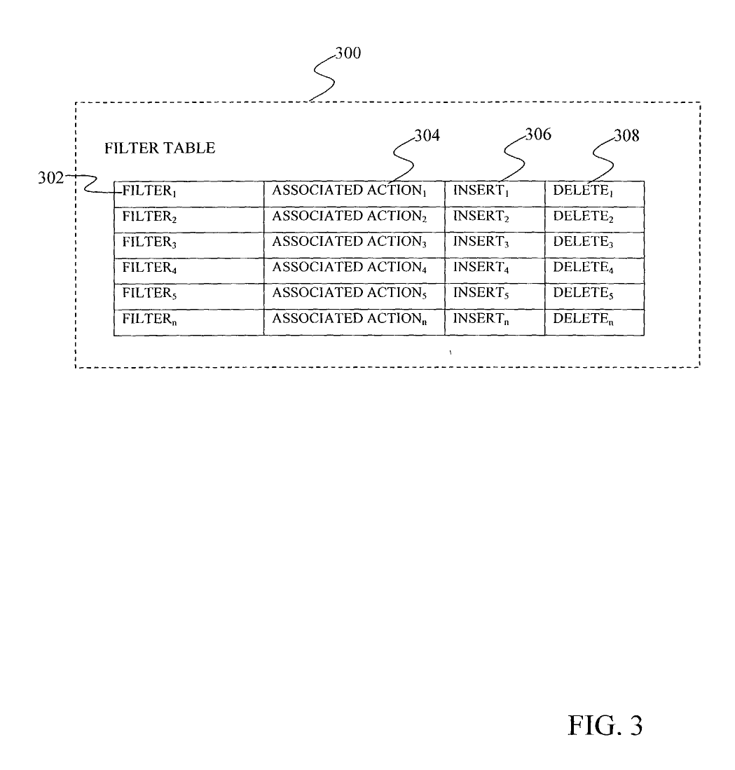

FIG. 3 depicts an exemplary filter table, or chain, that can be implemented as one of the filter chains discussed above in connection with FIG. 2. The filter table 300 includes a series of filters 302 that can be one of the 9-tuples or 4-tuples discussed above. Each row in the filter table 300 can also include an associated action 304, such as ACCEPT or DROP. The filter table 300 can also include an INSERT bit 306 and a DELETE bit 308, which can also optionally be arranged as multi-bit fields. Additions or deletions in either ACL table 104 or SITP table 106 will be reflected by corresponding additions or deletions in the graph of filter chains enforced by a forwarding element.

There are various ways in which the graph of filter chains can be updated. One method is to create updated filter tables, download them to a forwarding element, signal the forwarding element to call a delete function to delete each rule in the corresponding filter tables in the existing forwarding element, and then call a commit function to commit each rule in the updated filter tables to the forwarding engine (the component of the forwarding element that actually implements or enforces routing tables and forwarding tables). This method may be resource-intensive because the unchanged filters in the table are also deleted and reinstalled.

According to another technique, the filter tables can be updated by creating new updated filter tables, downloading them to a forwarding element, causing the forwarding element to call a scan function to compare the rules in the existing and corresponding updated tables in order to identify insertions and deletions, and finally to call add and delete functions to perform only the necessary additions and deletions on the existing filter tables. This method may also be resource intensive to the extent it requires the FE to cache two copies of the filter tables and calculate the difference of the two tables.

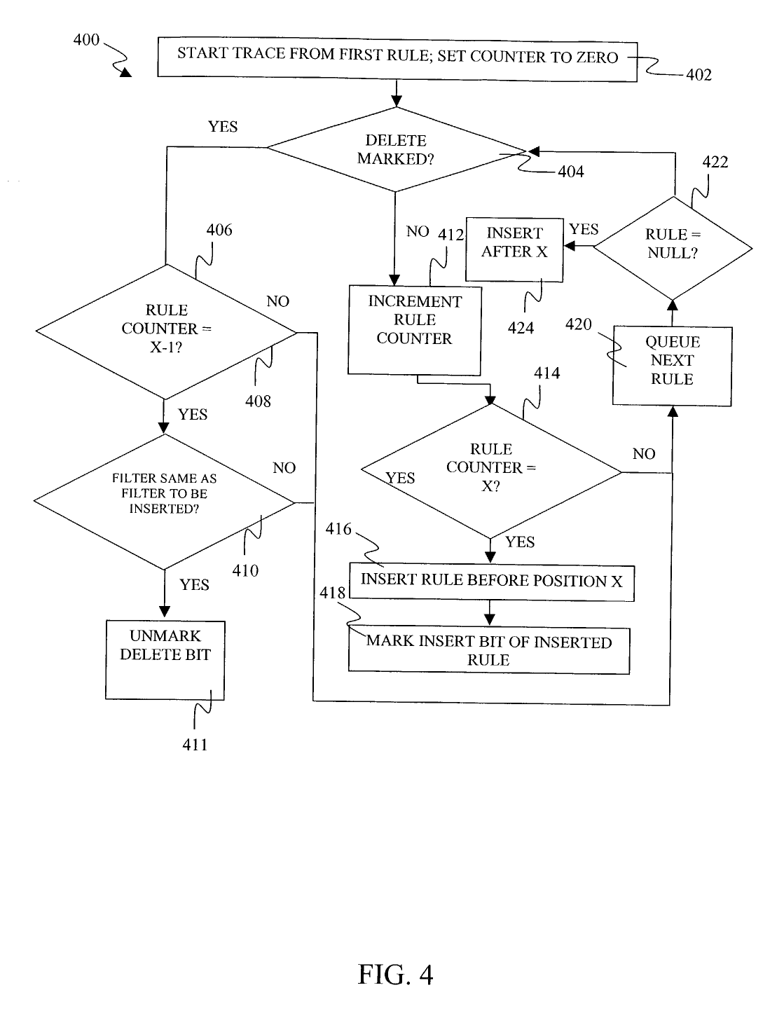

In yet another technique, rather than downloading updated filter tables to a forwarding element, only desired additions and deletions are downloaded to a forwarding element. Rules can be marked for addition, marked for deletion, and then actually deleted or inserted according to the procedures set forth in FIGS. 4, 5 and 6, respectively.

As shown in FIG. 4, a forwarding element can implement (400) an update specifying the addition or insertion of a rule into a position X in a filter table. A trace can be started at the first rule in the table and a rule counter can be set to zero (402). If the DELETE field is marked in the first rule (404) it can be next determined whether the counter equals X minus one (X−1) (406). If the counter equals X−1 and the filter is the same as the filter to be inserted, then the delete bit is unmarked (410, 411). Otherwise, the next rule can be queued (410, 411, 420). If the delete bit is not marked, then the counter can be incremented (412). Then, if the counter equals X, the filter can be added prior to the current, or queued, rule and an insert bit can be marked (416, 418). The next rule can then be queued (420). If the next rule queued is a null (i.e. the end of the filter table has been reached), rule can be inserted after the last entry in the rule table and the insert bit can be marked. Otherwise, the aforementioned can repeat until the rule to be inserted is in fact inserted at the appropriate entry.

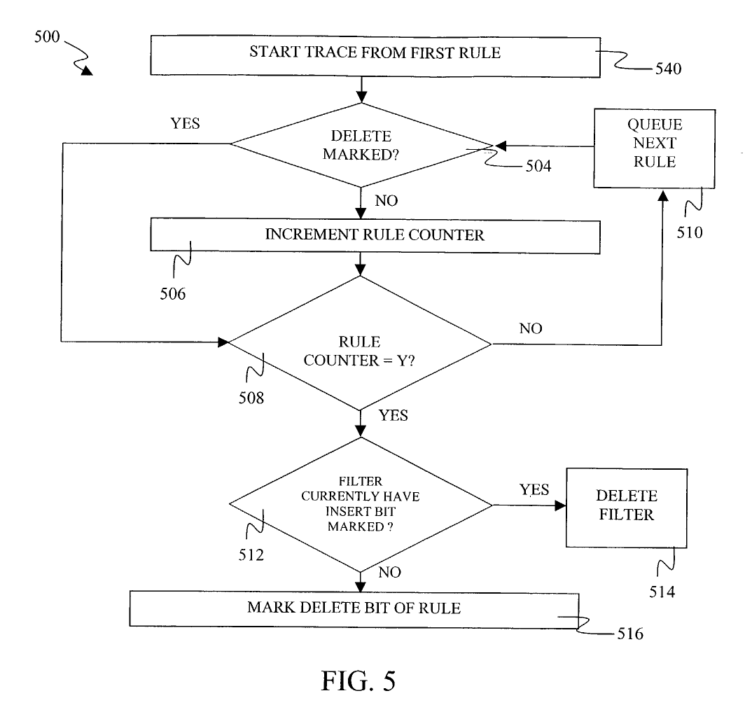

FIG. 5 depicts an exemplary protocol (500) pursuant to which a forwarding element can implement an update specifying the deletion of a rule from a position Y in a filter table. A trace can be started at the first rule in the table (502). If the DELETE field is not marked in the first rule, a rule counter, which is initially zero, is incremented (504, 506). Otherwise the rule counter is not incremented (504, 508). The next rule is queued (510) and this process is repeated (504-510) until the rule counter then has a value corresponding to Y (508, 512), the position from which the update specifies deletion of a rule. Then the forwarding element checks if the filter at this location is marked as INSERT (512). If yes, it deletes this filter from the forwarding engine cache (i.e. without commitment into the forwarding engine) (514). Otherwise it marks the DELETE bit of the queued rule (516). The INSERT and DELETE are not typically both marked in the illustrative embodiments discussed above.

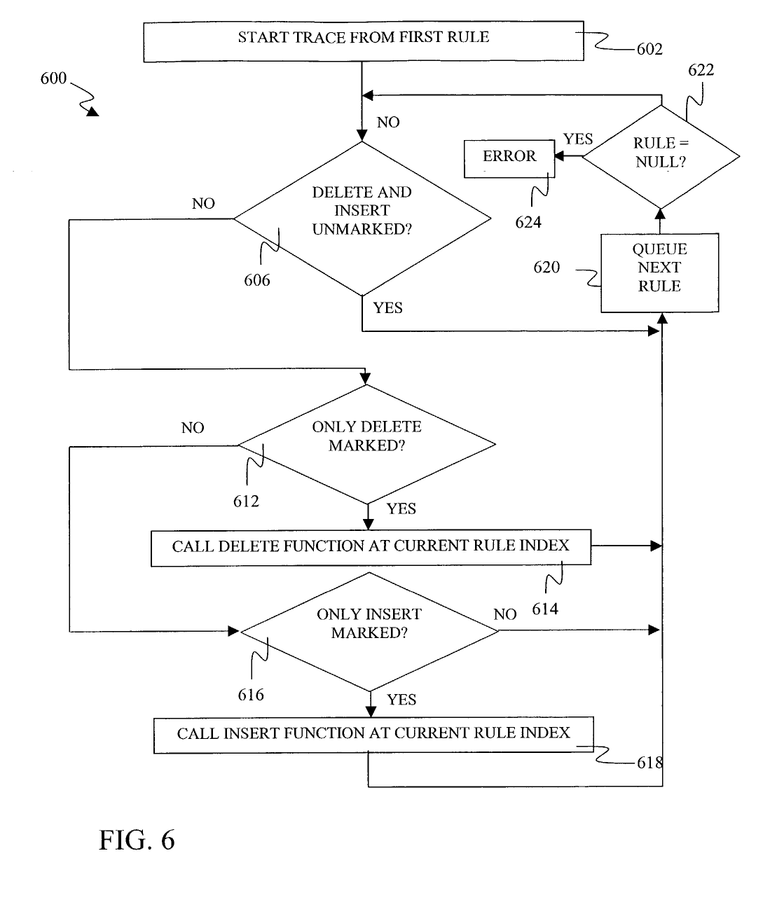

FIG. 6 illustrates the actual commitment of the marked additions and deletions pursuant to an exemplary protocol. Again a trace is started from the first rule in the table (602). If both the DELETE and INSERT bits are unmarked, the next rule is queued (606, 620). If only the DELETE bit is marked, a delete function is called at the current rule counter value, or index (612, 614), and then the next rule is queued (620). If only the INSERT bit is marked, an insert function is called at the current rule counter index (616, 618) and then the next rule is queued (620). If the next rule queued is a null, an error message can be returned (622, 624). This procedure can be followed until the end of the filter table is reached, at which time the FE can execute all deletions from the kernel, micro engine, etc. Even within this illustrative embodiment, there is no particular need to conduct the queries and evaluations in this particular order.

The process set forth above in connection with FIGS. 4-6 can optionally be repeated in series or parallel operation for each table in the graph of filter chains. In certain of the embodiments described herein, the graph of filter chains includes a clear filter table, a 4-tupe outer filter table, and a plurality of 3-tuple or 6-tuple inner filter tables.

The various techniques for updating the packet classifications (which are filter tables in certain of the illustrative embodiments) can be compared in terms of their memory requirements, computational resource demands, system call frequency and statistics management attributes. The first technique (which involves downloading an updated filter table, deleting the existing table, and committing each rule in the updated table) can involve maintenance of two versions of the filter tables on the forwarding element. The computational time is directly proportional to the length of the filter table in many such embodiments. The system call frequency is 2N′, where N is the maximum number of entries in the filter table. As to statistics management, the commitment process can involves a flush or refreshing of all statistics counters as the filter table is replaced.

The second method (which involves a comparison of the updated and existing tables and a selective insertion and deletion protocol), likewise requires that two versions of the table be stored at least temporarily on the forwarding element. Moreover, the system call frequency is significantly lower and the statistics flush problem is usually not present. However, the computational complexity is proportional to N squared.

In the third technique (that discussed in connection with FIGS. 4-6) memory space utilization is reduced by approximately a factor of one, no statistics flush occurs, and system call frequency is much less than 2N. Computational complexity is directly, rather than exponentially, related to the size of the filter table (N).

As noted above, the updating techniques are not limited to filter rules, ON systems, VPNS, or security-aware environments. The updating techniques can be advantageously be implemented in any packet-classification based network service, including firewall and quality of service (QoS) environments.

The packet classification chains need not be “graph” or table form. Rather, any desired classification rule set can be provided.

Similarly, it will be apparent to those skilled in the art that the specific protocols described above, and their particular sequencing, are merely illustrative embodiments selected for a particular network architecture and security protocol. Unless specifically stated otherwise, the steps of each protocol can be performed in a difference sequence.

The foregoing techniques can be implemented in an almost limitless number of additional manners dictated by particular network architecture (s), security protocols, and other design parameters. The foregoing proposed modifications will be understood as merely illustrative by those skilled in the art. It will be understood that various modifications may be made without departing from the spirit and scope of the invention. Accordingly, other embodiments are within the scope of the following claims.

What is claimed is:

1. A system comprising:
a network device having a plurality of interfaces to receive and transmit packets of data, the network device including a forwarding element to apply classification rules to the packets; and
a packet classification chain that resides at least temporarily on the network device, wherein the chain includes classification rules, an associated action, and an update field to trigger insertion or deletion of the rule in the chains.

2. The system of claim 1, further comprising a control element associated with the network device to create a packet classification chain update that specifies one or more modifications to the classification chain.

3. The system of claim 1 or 2, further comprising an engine associated with the forwarding element to modify the packet classification chain in response to a packet classification chain update.

4. The system of claim 1, wherein the packet classification chain includes tables of filter rules.

5. The system of claim 1, wherein the update field is to trigger insertion of the rule, and wherein the system further comprises a second field to trigger deletion of the rule.

6. The system of claim 2, wherein the control element and forwarding element are part of an open network router or gateway.

7. The system of claim 2, wherein the control element and forwarding element are embedded on the same device.

8. The system of claim 4, wherein the filter rules apply to packet headers encrypted with a security protocol.

9. The system of claim 8, wherein the packet classification chain includes information associated with decryption keys or decryption algorithms.

10. An article comprising a machine-accessible medium having associated data, wherein the data, when accessed, results in a machine performing:
receive packet classification update information;
access a packet classification chain that includes packet classification rules, an associated action, and an update field to trigger insertion or deletion of the rule;
modify the update field based on information contained in the update information; and
modify the classification chain based on information contained in the update field.

11. The article of claim 10, further comprising instructions to access within the classification chain a first field to trigger insertion of a rule and a second field to trigger deletion of a rule.

12. The article of claim 10, further comprising instructions to call a delete function or an insert function based on information contained in the field.

13. The article of claim 10, 11 or 12, further comprising instructions to receive packet classification update information that includes filter rule updates.

14. The article of claim 10, wherein the instructions cause the update field to be modified before the classification chain is modified.

15. The article of claim 10, further comprising instructions to access, within the classification chain, tables of filter rules.

16. The article of claim 10, wherein the machine-readable medium resides on a network device that is part of an open network system.

17. The article of claim 10, further comprising instructions to access, within the classification chain, filter rules that apply to packet headers encrypted with a security protocol.

18. The article of claim 16, further comprising instructions to access, within the classification chain, information associated with decryption keys or decryption algorithms.

19. The article of claim 10, further comprising instructions to receive a classification update from a control element that is disposed on a different device than the machine-readable medium.

20. A method comprising:
receiving packet classification update information;
accessing a packet classification chain that includes packet classification rules, an associated action, and an update field to trigger insertion or deletion of the rule;
modifying the update field based on information contained in the update information, and
modifying the classification chain based on information contained in the update field.

21. The method of claim 20, further comprising instructions to access, within the classification chain, a first field to trigger insertion of a rule and a second field to trigger deletion of a rule.

22. The method of claim 20, further comprising calling a delete function or an insert function based on information contained in the update field.

23. The method of claim 20, 21, or 22, further comprising receiving packet classification update information that includes filter rule updates.

24. The method of claim 20, wherein the update field is modified before the classification chain is modified.

25. The method of claim 20, further comprising accessing, within the classification chain, tables of filter rules.

26. The method of claim 20, further comprising accessing, within the classification chain, filter rules that apply to packet headers encrypted with a security protocol.

27. The method of claim 26, further comprising accessing, within the classification chain, information associated with decryption keys or decryption algorithms.
